(19) United States
(12) Patent Application Publication
(10) Pub. No.: US 2017/0255623 A1
(43) Pub. Date: Sep. 7, 2017

(54) CONTENT MANAGEMENT PLATFORM AND DEVICE FOR DISPLAYING SUBSCRIPTION AND USER-COMMISSIONED CONTENT

(71) Applicant: Electric Objects, Inc, New York, NY (US)

(72) Inventors: Jacob LEVINE, New York, NY (US); Zoe SALDITCH, New York, NY (US); Bill COWLES, New York, NY (US); Luke CHAMBERLIN, New York, NY (US)

(21) Appl. No.: 15/060,570

(22) Filed: Mar. 3, 2016

(51) Int. Cl. G06F 17/30

(52) U.S. Cl. CPC G06F 17/30029; G06F 17/30056; G06F 17/30867; G06T 2200/24; G06F 3/0482

(57) ABSTRACT

The invention relates to providing user-commissioned multimedia content, subscription-based multimedia content, and other types of multimedia content displayed through one or more user display devices that may be remotely controlled by different devices over a network and by different users. A system may control functionality and content of a digital picture frame device and other types of display devices. One or more digital picture frame devices may be associated with a user, who may use the system to remotely control and procure content for digital picture frame devices.

### FIELD OF THE INVENTION

The invention relates to systems and methods of providing user-commissioned multimedia content, subscription-based multimedia content, and other types of multimedia content displayed through one or more user display devices that may be remotely controlled by different devices over a network and by different users.

### BACKGROUND OF THE INVENTION

Digital picture frame devices are devices for displaying multimedia content (e.g., video, still images, etc.). Conventional digital picture frame devices typically display multimedia content stored in on-board memory. A user typically transfers multimedia content from a storage device (e.g., memory stick) or computer device through a wired or wireless connection, thereby limiting access to multimedia content that may be available online. Although some digital picture frame devices may access the Internet, these devices still do not facilitate acquiring content in an easy and comprehensive manner. These and other drawbacks exist.

### SUMMARY OF THE INVENTION

The invention described herein relates to a system and method providing user-commissioned multimedia content, subscription-based multimedia content, and other types of multimedia content displayed through one or more display devices that may be remotely controlled by different devices over a network and by different users. The one or more display devices may include a digital picture frame device, a laptop computer, a tablet computer, a smartphone, and/or other device that is equipped to display multimedia content. As used herein for illustration and not limitation, examples of a display device will include a digital picture frame device, although other types of display devices may be used as well. As used herein throughout, the term “multimedia content” will be used interchangeably with “content.”

Content Management/Provisioning Functions from the Cloud

The system may include a computer system that may control content displayed at a display device through a network such as the Internet. Such display devices may be registered with the computer system such that the computer system may direct content to appropriate display devices.

In an implementation, the computer system may provide artist-specified shows to which users may subscribe. A show may include artist-provided multimedia content that is displayed in a particular order. For example, the computer system may receive the artist-provided multimedia content (either live or in advance) for display through display devices. Upon subscription, the show, which may be streamed live, may be provided to a user's display device. In some instances, an artist may specify a limit to the number of subscribers. In these instances, the computer system may count the number of subscribers and no longer allow further subscriptions to the show after the maximum number has been reached.

In an implementation, the computer system may facilitate the commission of artwork by an end user (e.g., an owner/operator of a display device) to an artist (e.g., an individual or entity that provides content to be displayed on a display device). For example, the computer system may obtain one or more art parameters from an end user and provide the art parameters to an artist, who may then provide the commissioned content for display at a user's display device. In this manner, the user may obtain custom content for display on the user's display device. An operator of the computer system may, in some instances, receive a fee for facilitating such commission.

In an implementation, the computer system may provide a content marketplace (e.g., a content interface) in which content may be selected and downloaded for display at a user's display device. Such selections may be made from a display device, a client device operated by the user, or other device. In some instances, the content provided by content marketplace may be limited. For example, content may be limited in the number of total downloads such that once the limit is exceeded, such content is no longer available for download. Alternatively or additionally, content may be limited by time in that computer system provides the content only before a certain date/time, during a specific time period (e.g., during holidays), and/or during other times that are subject to a time restriction.

In an implementation, the computer system may control what content is downloaded to, displayed at, or removed from a display device, thereby facilitating control of a display device from the cloud (e.g., via a device connected to the computer system via a network). For example, a user may control the content of a display device from a client device (e.g., a desktop computer or mobile device) through commands issued from the client device. Such commands may be transmitted from the client device to the computer system over a network via a website exposed by the computer system and/or through a dedicated application (e.g., a mobile “app”) executing on the client device.

In an implementation, the computer system may control one or more device settings, in a manner similar to controlling content from the cloud. The device settings may include, for example, screen brightness, power on/off, standby, volume, and/or other settings.

In an implementation, the computer system may facilitate mirroring a display of a remote device onto a display device. For instance, an end user may subscribe to the remote device and the computer system may obtain content being displayed on the remote device. The computer system may then provide the obtained content to the display device. In this manner, end users of display devices may subscribe to and mirror display devices or other devices of other users.

### Display Device Functions

A given display device may also facilitate richer experiences for end users by displaying content that may be controlled from the cloud (as described briefly above and more fully described herein throughout), as well as providing further functions and accessories.

For example, in an implementation, a display device may detect of users within proximity of the display device. For instance, the display device may pair with an end user's mobile phone via a BLUETOOTH or other connection and identify the end user. If the end user is registered to use the system and is associated with a stored user profile (either at the display device and/or on the cloud at the computer system), the display device may identify and display content based on the user profile. In this manner, different users may be automatically detected and content preferred by the detected user may be displayed.

In an implementation, a display device may discover other display devices (e.g., via BLUETOOTH or other connections). The display devices may synchronize clocks and automatically show content that remains in sync across multiple screens. The discovery process may be repeated with multiple display devices such that they may be synchronized. In some instances, the discovered display devices may coordinate with one another such that one display device displays first image in a sequence and a second display device displays a second image in the sequence. Other types of coordination between discovered display devices may be used as well.

In an implementation, a display device (or the computer system) may determine that a user is viewing content for potential download to display device. For example, the display device may receive an indication that an end user associated with the display device is previewing content. The display device may, in response, pre-emptively download (or begin to download) the content being previewed even without a request from the end user to do so. In this manner, should the user decide to download the content, the content is already at least partially downloaded to the display device, reducing perceived download times.

In an implementation, a display device (or the computer system) may alter content displayed at the display device. Such alteration may be based on ambient conditions (e.g., lighting conditions), a data stream, and/or other information. For example, the display device may overlay or otherwise incorporate a data stream (such as a weather or sports feed, messages such as electronic mail or social media messages) into content displayed at the display device.

In an implementation, a display device (or the computer system) may predict and display content that may be preferred by the user based on user profile information, colors, mood, type of content, etc. In some instances, the display device may cause the predicted content to be displayed on the display device without user intervention. In other instances, the display device may provide recommendations to the relevant end user based on the predicted content.

In an implementation, a display device may be locked in that the display device executes only one application at a time, with no ability to switch between applications

In an implementation, a display device may provide a loading indicator to a remote device (such as the computer system). The loading indicator may indicate its “loading” state information to a remote server, which indicates that state on another one of the user's devices (e.g., on a user's client device, through a website, etc.).

In an implementation, a display device may automatically control device settings based on ambient conditions, such as lighting conditions. Brightness controller algorithm: Using rolling averages from the ambient light sensor to predict and set an appropriate brightness range for its environment.

In an implementation, a display device (or the computer system) may generated a custom sequence of images using multiple images and animate the sequence at a set framerate more efficiently than the GIF file format.

The one or more display devices may include a digital picture frame device, a laptop computer, a tablet computer, a smartphone, and/or other device that is equipped to display multimedia content. As used herein for illustration and not limitation, a display device may be referred to as a digital picture frame device, although other types of user display devices may be used as well.

Various other aspects of the invention will be apparent through the detailed description of the invention and the drawings attached hereto. It is also to be understood that both the foregoing general description and the following detailed description are exemplary and not restrictive of the scope of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates a system for providing user-commissioned content, subscription-based content, and other types of content displayed through one or more display devices, according to an implementation of the invention.

FIG. 2 illustrates a computer system for providing user-commissioned content, according to an implementation of the invention.

FIG. 3 illustrates a display device for obtaining and displaying user-commissioned content, according to an implementation of the invention.

FIG. 4A illustrates a front view of an exemplary digital picture frame device, according to an implementation of the invention.

FIG. 4B illustrates a rear view of an exemplary digital picture frame device, according to an implementation of the invention.

FIG. 4C illustrates a side view of an exemplary digital picture frame device, according to an implementation of the invention.

FIG. 5 depicts a process flow diagram for providing multimedia content to a display device, according to an implementation of the invention.

### DETAILED DESCRIPTION OF THE INVENTION

The invention described herein relates to a system and method for providing user-commissioned content, subscription-based content, and other types of content displayed through one or more user display devices.

### System Components

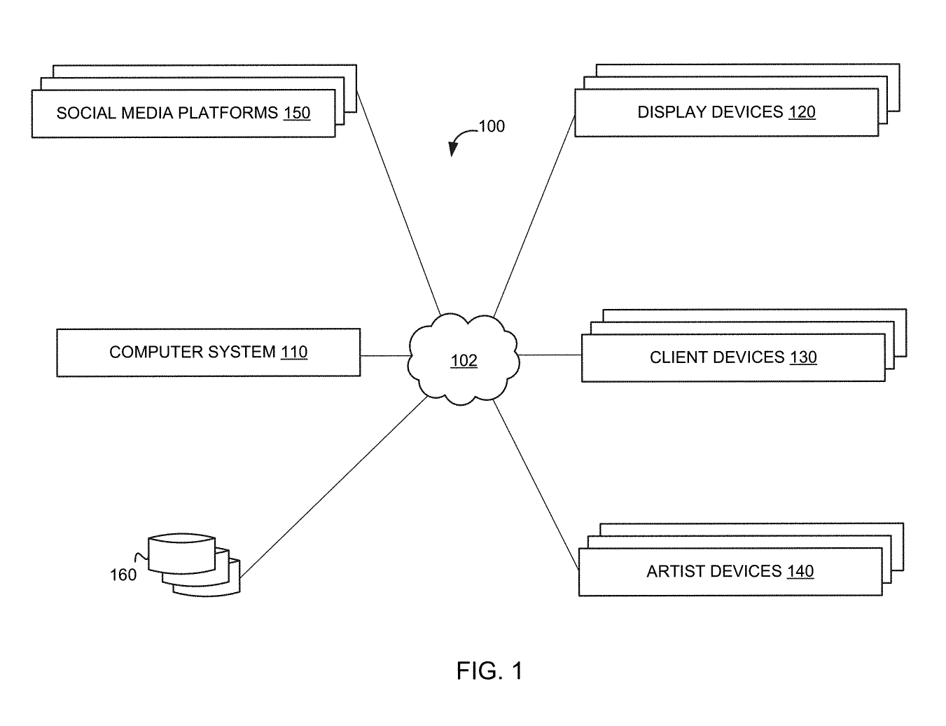

FIG. 1 illustrates a system 100 for providing user-commissioned content, subscription-based content, and other types of content displayed through one or more display devices, according to an implementation of the invention. System 100 may include a computer system 110, one or more display devices 120 (illustrated in FIG. 1 as display devices 120A, 120B, . . . , 120N), one or more client devices 130 (illustrated in FIG. 1 as client devices 130A, 130B, . . . , 130N), one or more artist devices 140, one or more social media platforms 150, one or more databases 160, and/or other components.

Computer system 110 may remotely control and/or provide multimedia content to one or more display devices 120. A display device 120 may obtain multimedia content from various sources such as from computer system 110, other display devices 120, a client device 130, an artist device 140, social media platforms 150, a memory device (e.g., a device removably or communicably coupled to the display device), and/or other content sources. A client device 130 may be operated by an end user to remotely control or otherwise provide content to display device 120. For instance, an end user may use take a photograph using client device 130 and upload the photograph (directly or indirectly) to display device 120. Social media platforms 150 may include platforms to which users upload content to be provided to others. Examples of social media platforms 150 include, without limitation, Facebook, Twitter, YouTube, Instagram, Picassa, and LinkedIn. In this manner, display device 120 may obtain multimedia content (e.g., photos) from various social media platforms.

As used herein multimedia content shall mean digital images and/or videos which may be displayed on the digital picture frame. Digital images may comprise one or more digital image formats including, but not limited to, JPEG, GIF, BMP, EXIF, PCD, TIFF, etc. Digital videos may comprise one or more digital video formats including, but not limited to, MPEG, AVI, QuickTime, MOV, etc.

### Computer System 110

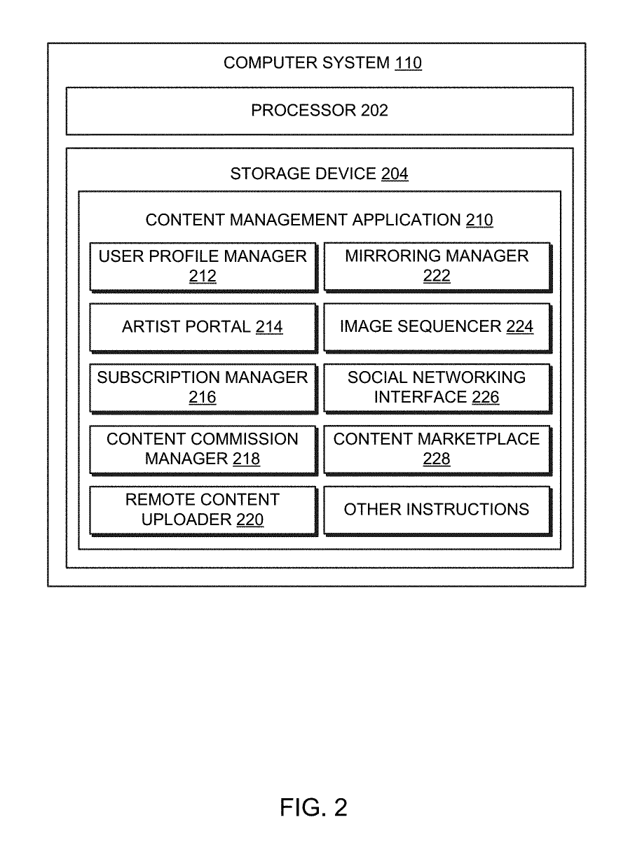

FIG. 2 illustrates a computer system 110 for providing user-commissioned content, according to an implementation of the invention. Computer system 110 may include one or more physical processors 202, one or more storage devices 204 (which may store a content management application 210), and/or other components. Processors 202 may be programmed by one or more computer program instructions. For example, processors 202 may be programmed by content management application 210 and/or other instructions that program computer system 110.

The instructions may include, without limitation, a user profile manager 212, an artist portal 214, a subscription manager 216, a content commission manager 218, a remote content uploader 220, a mirroring manager 222, an image sequencer 224, a social networking interface 226, a content marketplace 228, and/or other instructions that program computer system 110 to perform various operations, each of which are described in greater detail herein. As used herein, for convenience, the various instructions will be described as performing an operation, when, in fact, the various instructions program the processors 202 (and therefore computer system 110) to perform the operation.

### Registering Users and Generating User Profiles

In an implementation, user profile manager 212 may register a user to use the system. User profile manager 212 may generate and maintain a user profile associated with a registered user. The user profile may include, for example, an identification of a user's various devices, access control information, device setting preferences, user demographic information, social media profile, user activity information, and/or other information related to the user. The user profile may be stored in a user profile database, such as in a database 160.

The user's various devices may include, for example, the user's display devices 120, the user's client devices 130, and/or other devices that the user has registered (e.g., identified to the system) or otherwise is known to be used by the user. To register a display device 120, using a client device 130 (e.g., a device programmed with device management application), the user may scan a barcode located on the display device 120 to register the device. Alternatively or additionally, the user may simply provide an identifier associated with the user display device.

The identification of the user's display devices 120 may be used to determine where multimedia content should be provided (e.g., to which one of the user's display devices 120—assuming more than one such device is associated with the user) as well as provide management functions that allow the user to control such display devices 120 remotely. For instance, a user may login to a website operated by the system in order to view, manage, and control the user's display devices 120.

The access control information may include information that indicates whether and which ones of other users' devices (if any) the user may provide content. For example, another user may grant the user access to provide content to the other user's display devices 120. If so, user profile manager 212 may store an indication of such access. Likewise, if the user has granted control of the user's display devices 120 to another user, user profile manager 212 may store an indication of such grant in the user profile. As described herein, a given user may grant another user with access to control either all or a portion of the given user's display devices 120.

The device setting preferences may indicate device settings preferred by the user. The device settings may include, without limitation, display settings (e.g., brightness, contrast, etc.), audio settings (e.g., volume, bass, treble, etc.), timer settings (e.g., when to power on/off, go into standby mode, etc.), scroll settings (e.g., whether to scroll and a rate at which to scroll, etc.). A global device setting preference may be used to control all of the user's display devices while an individual device setting preference may be used to individually control a corresponding user display device. The device setting preferences may be used to control the settings of a display device 120, which may be subject to manual control at the display device (i.e., a manual adjustment to any of the device settings at the device may override the device setting preference).

The user demographic information may include a name, address, ethnicity, age, gender, and/or other information known about the user.

The social media profile may include social media account information (e.g., identification of a social media platform, a username, an authentication credential—for instances in which the user has granted the system to access the user's social media account to post or download content), an identification of friends or other associations, and/or other social media information.

The user activity information may include an indication of the user's activity such as, without limitation, multimedia content obtained by the user for display at a display device 120, any multimedia content (e.g., games, videos view, etc.) interacted with using the display device (including a duration and number of such interaction), and/or other user activity known by the system.

### Artist Portals

In an implementation, artist portal 214 may provide an artist interface that receives artist-provided multimedia content. For example, photographers, cartoonists, painters, and/or other artists may use the artist portal upload their artwork (in the form of multimedia content) to be made available to users for download to their display devices 120. In some instances, the artist interface may be used to specify a particular user or display device 120 to which to provide the artist-provided multimedia content. In these instances, the particular user may have commissioned the artist to provide such content, as described herein.

### Managing Subscription-Based Content

In an implementation, subscription manager 216 may maintain and manage content subscriptions that cause subscription-based content to be provided to display devices periodically over time, which may be limited. Subscription manager 216 may provide a listing of subscription-based content that is available for subscription. Subscription manager 216 may receive one or more subscriptions from an end user and store such subscription in a corresponding user profile for the end user. A given subscription may specify which one or more (or all) of the user's display devices should receive the subscription-based content. Such subscribed-to content may be automatically provided to one or more of the user's display devices 120 (and/or to any other users' display devices 120 to which the end user has access).

Subscription-based content may include one or more subscription-based channels. A given channel may relate to content provided by a given artist or other content provider. Alternatively or additionally, a given channel may relate to groupings of content that share similar characteristics (e.g., subject matter, genre, color, etc.). The groupings may be made automatically by subscription manager 216 based shared characteristics of the content. Alternatively or additionally, the groupings may be made by artists or other content providers who provided the content. In some implementations, subscription manager 216 may group content into channels based on input from end users.

In an implementation, a given subscription may be limited by an artist/provider of the subscription-based content associated with the subscription. For example, an artist/provider may wish to limit the number of subscriptions that are available at any given time such that if the limit is reached, subscription manager 216 no longer allows further subscriptions from other end users. Furthermore, in some implementations, subscription manager 216 may withdraw a subscription from a user if the user's display devices 120 have not displayed the limited subscription content for a sufficient period of time or since a threshold time has elapsed. In this manner, limited subscriptions may be withdrawn from users that do not use or display such limited content so that the limited subscriptions may be made available to other end users.

In an implementation, the user may subscribe to a channel that provides multimedia content based on a selected category and predetermined schedule. Categories of digital channel may be based on the artist, genre, mood, type of content, and the like. For example, if the user subscribed a “motivational” theme channel, subscription manager 216 may provide the user “motivation” themed digital images and/or videos at a predetermined time such as 7 AM every morning while the user is waking up.

In another implementation, subscription manager 216 may provide the content based on an action or trigger of a user device. For example, multimedia content marketplace engine 334 may provide multimedia content in response to a particular event in the user's calendar. In one implementation, the user may subscribe to limited edition subscriptions of multimedia content. For example, multimedia content marketplace engine 324 may provide the user one or more multimedia content subscriptions which may be limited. In one implementation, the limited edition subscriptions may be limited to a particular number of total subscriptions. In another implementation, the limited edition subscriptions may be limited to a particular time period.

Subscription manager 216 may provide recommendations of multimedia content (including subscription-based content/channels) based on the user profile. For instance, subscription manager 216 may recommend a particular channel or content based on a user's preferences, social media, user activity, and/or other information available in the user profile.

### Managing User-Commissioned Artwork

In an implementation, content commission manager 218 may facilitate the commission of artwork from an end user to an artist. For instance, content commission manager 218 may provide samples of artwork (in the form of multimedia content) provided from an artist using artist portal 214 to end users. Content commission manager 218 may receive, from an end user, a request to commission artwork from the artist. The request may include one or more art parameters that specify the desired artwork. The art parameters may include, without limitation, a size, a color, a theme, a mood, a genre, a desired completion date, a desired price, and/or other characteristic of the artwork to be provided by the artist. Content commission manager 218 may forward the request to the artist. In addition, content commission manager 218 may include contact details of the requesting end user so that the artist can follow-up with the requesting end user. Alternatively or additionally, content commission manager may provide a two-way communication interface (e.g., a website) in which the artist and the requesting end user may communicate to finalize plans (including price negotiations). Once the artist has completed any commissioned artwork, the artist may use the artist portion 214 to upload the artwork, which may then be provided to one or more of the specified user's display devices 120. In an implementation, content commission manager 218 may keep track of commissioned content and any payment for such content in order to bill the artist and/or the requesting end user for at least a portion of the payment. In some implementations, content commission manager 218 may facilitate payment from the requesting end user to the artist, in which case content commission manager 218 may extract its associated fee.

### Remote Content Uploads

In an implementation, remote content uploader 220 may obtain content uploaded from a user to be provided to one or more of the end user's display devices 120. For example, remote content uploader 220 may provide a website or other interface that the end user may use to identify the target display devices 120 (which may include the end user's display devices or display devices that the end user is authorized to access) and upload content for delivery to the target devices. Alternatively or additionally, remote content uploader 220 may obtain such identification and content from the end user via a client device 130 programmed with a remote management application. In any event, remote content uploader 220 may obtain the uploaded content and automatically provide the content to the specified end user display devices 120. In this manner, the user may, for example, take photographs, videos, audio, etc., from any location that has access to remote content uploader 220 (whether via website or remote management application) and cause such content to be automatically downloaded to a display device 120.

### Content Mirroring

In an implementation, mirroring manager 222 may receive a request to mirror content from a remote device onto a display device 120. For instance, an end user may request to mirror the content of a second device onto a first device so that whatever is displayed on the second device is also displayed on the first device. In this instance, mirroring manager 222 may obtain the content being displayed at the second device and provide such content to be displayed at the first device. In some instances, mirroring manager 222 may synchronize such content display such that as soon as first content displayed at the second device is changed to second content, the second content may be displayed at the first device. The first device may include an end user's display device 120. The second device may include the end user's second display device 120, a second end user's display device 120, or a client device 130, so long as mirroring manager 222 has access to what is being displayed on the second device.

In an implementation, image sequencer 224 may generate an image sequence from a plurality of individual images.

### Social Networking

In one implementation, social network interface 226 may provide multimedia content based on one or more aspects of the user's social networking. For example, social network interface 226 may automatically select and stream multimedia content based on one or more aspects of the user's social networking. In one implementation, social network interface 226 may recommend multimedia content based on data streams received from one or more of the user's social media feeds. For example, social network interface 226 may recommend one or more digital images and/or videos based on a user's Twitter feeds, Facebook status, Instagram feeds, and the like.

In one implementation, social network interface 226 may provide or automatically select multimedia content associated with the user's social media feed. For example, as the user downloads a digital image into Instagram, social network interface 226 may automatically download that same digital image to the user's digital picture frame. In another implementation, social network interface 226 may provide multimedia content from the social media feeds of friends or acquaintances. For example, social network interface 226 may provide the user multimedia content from one or more of the user's friends social media feeds that may be selected by the user to be downloaded to a digital picture frame. In another implementation, the social network interface 226 may enable the user to send multimedia content which is selected from the multimedia content marketplace engine 324 and/or from their digital picture frame to a friend. For example, the user may select digital images downloaded to the user's digital picture frame a friends digital picture frame for display.

In another implementation, social network interface 226 may enable a user to commission artwork from one or more artists. For example, the user may utilize the social network interface 226 to facilitate a dialogue between an artist and the user to create a custom piece of multimedia content for the user. For example, the user may commission an artist to create a piece of artwork which may then be provided to the user via the social network interface 226 as multimedia content.

In one implementation, social network interface 226 may enable the provided multimedia content for selection by the user. For example, the user may select one or more pieces of multimedia content provided by the social network interface 226 to be downloaded and/or streamed to the user's registered digital picture frame. As another example, in response to a user search, social network interface 226 may provide one or more digital images and/or videos associated with the user social networking. The user may select one or more of the provided digital images and/or videos associated with the user's social networking to be downloaded and/or streamed to the user's digital picture frame.

### Content Marketplace

In one implementation, content marketplace 228 may provide multimedia content that is available for download. Content marketplace 228 may store (in a marketplace databases, such as a database 160) information associated with the multimedia content such as title, artist, credit information, date of creation, and/or other information associated with the multimedia content. The marketplace database may be accessible to computer system 110 via a remote or external network connection (e.g., outside of a firewall), such as the Internet. For example, the marketplace database may include a storage device that is remotely accessible to computer system 110. In another implementation, the marketplace database may include one or more internal databases that are internally accessible to the computer system 110.

In an implementation, content marketplace 228 may obtain results related to a user search that are available from the marketplace database. In an implementation, content marketplace 228 may receive and process a user search that relates one or more pieces of multimedia content. The user search may include a search parameter used to obtain search results. For example, the search parameter may include one or more search terms (e.g., keywords, phrases, etc.), categories of multimedia content, artist, titles, and/or other parameters used to search for or otherwise obtain information sought by a user. The user search may include, without limitation, a search request, a command (e.g., a structured set of words or phrases), and/or other input. The user search may be received via one or more input formats.

In an implementation, content marketplace 228 may process the user search to obtain results related to the user search. For example, content marketplace 228 may execute a search that returns information related to the search parameter, execute a command that produces output related to the search parameter, or otherwise obtain results related to the search parameter. In an implementation, content marketplace 228 may process the user search using the exact words or phrases from the user search (e.g., using the exact words of the search parameter). In another implementation, content marketplace 228 may execute a search or command (or otherwise cause the search or command to be executed) using the exact words of the search parameter as input by the user. For example, the user search may include a search request that includes a search parameter “oceans.” Content marketplace 228 may search the multimedia content database with information relating to “oceans.” For instance, content marketplace 228 may identify one or more digital images and/or videos related to oceans that may be downloaded or streamed to the digital picture frame

In one implementation, content marketplace 228 may provide one or more pieces of multimedia content for selection by the user. For example, the user may select one or more pieces of multimedia content provided by the content marketplace 228 to be downloaded and/or streamed to the user's registered digital picture frame. As another example, in response to a user search, content marketplace 228 may provide one or more digital images and/or videos associated with the user search. The user may select one or more of the provided digital images and/or videos associated with the user search to be downloaded and/or streamed to the user's digital picture frame.

In one implementation, content marketplace 228 may provide the user one or more limited edition pieces of multimedia content. For example, one or more limited edition digital images and/or videos may include limited availability or restricted access. In one implementation, limited edition multimedia content may be limited or restricted to a particular number of total downloads by users. In another implementation, limited edition multimedia content may be limited to a particular time period. For example, a limited edition digital image may only be available for a certain time period, such as 24 hours, or to a certain number of downloads, e.g. 1,000 downloads. In another implementation, content marketplace 228 may provide the user access to attend a “live” multimedia content. For example, content marketplace 228 may provide multimedia content associated with one or more live performances, such music concerts, speeches, or performances, which are streamed to the user's digital picture frame in real time. In one implementation, the “live” multimedia content may be limited to a particular number of users attending or streaming the multimedia content. In another implementation, the “live” multimedia content may be limited to a particular time period.

The system and method may provide users subscription-based multimedia content channels. In one case, the user may subscribe to a channel which provides multimedia content based on a selected category and predetermined schedule. The system and method may provide recommendations of multimedia content based on the user profile. The system and method may also provide multimedia content based on one or more aspects of the user's social networking. Further, the system and method may manage the functionality and/or settings of the user's digital picture frame.

In an implementation, content marketplace 228 may provide users subscription-based multimedia content channels. In one case, the user may subscribe to a channel which provides multimedia content based on a selected category and predetermined schedule. Categories of digital channel may be based on the artist, genre, mood, type of multimedia content, and the like. For example, if the user subscribed a “motivational” theme channel, content marketplace 228 may provide the user “motivation” themed digital images and/or videos at a predetermined time such as 7 AM every morning while the user is waking up. In another implementation, the content marketplace 228 may provide the multimedia content based on an action or trigger of a user device. For example, content marketplace 228 may provide multimedia content in response to a particular event in the user's calendar. In one implementation, the user may subscribe to limited edition subscriptions of multimedia content. For example, content marketplace 228 may provide the user one or more multimedia content subscriptions which may be limited. In one implementation, the limited edition subscriptions may be limited to a particular number of total subscriptions. In another implementation, the limited edition subscriptions may be limited to a particular time period.

In another implementation, content marketplace 228 may provide recommendations of multimedia content based on the user profile. For example, content marketplace 228 may provide recommendations for digital images and/or videos based one or more of the user's existing multimedia content, user preferences, location information, social media account information, calendar information, digital picture frame settings. For example, content marketplace 228 may recommend multimedia content based on one or more of the weather in the user's current location. In an implementation, content marketplace 228 may filter subscribed to channels based on the user profile. In another implementation, content marketplace 228 may receive provide recommended multimedia content for the user based on the user's mood, preferred type of artwork, favorite colors, and the like which may be inputted at any time.

Computer system 110 may be configured as a server computing device, a personal computing device, a laptop computer, a tablet computer, and/or other computing device that is programmed with content management application 210.

### Display Device 120

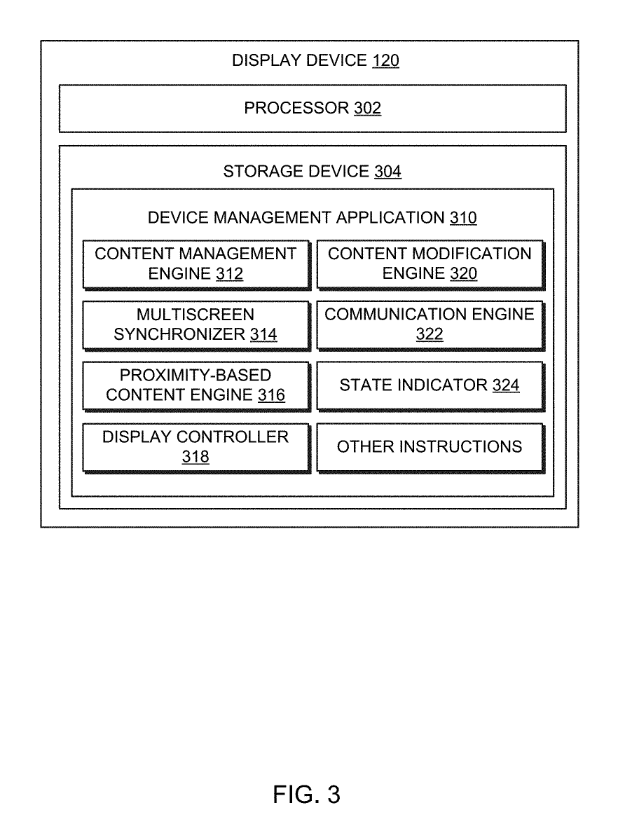

FIG. 3 illustrates a display device 120 for obtaining and displaying user-commissioned content, according to an implementation of the invention. Display device 120 may include one or more physical processors 302, a storage device 304 (which may store a device management application 310), and/or other components (e.g., components illustrated in FIG. 3). Processors 302 may be programmed by one or more computer program instructions. For example, processors 302 may be programmed by device management application 310 and/or other instructions. Device management application 310 may include instructions that program display device 120. Display device 120 may be configured as a digital picture frame, although other devices (e.g., a laptop computer, a tablet computer, a smartphone, etc.) that includes a display and may be programmed with device management application 310.

The instructions may include, without limitation, a content management engine 312, a multiscreen synchronizer 314, a proximity-based content engine 316, a display controller 318, content modification engine 320, a communication engine 322, a state indicator 324, and/or other instructions that program display device 120 to perform various operations, each of which are described in greater detail herein. As used herein, for convenience, the various instructions will be described as performing an operation, when, in fact, the various instructions program the processors 302 (and therefore display device 120) to perform the operation.

### Managing Content at a Display Device

In one implementation, content management engine 312 may receive multimedia content from a data input unit of display device, from a client device 130, and/or from computer system 110. In one implementation, content management engine 312 may receive information associated with the multimedia content including title, artist, credit information, date of creation, and/or other information associated with the multimedia content.

In one implementation, content management engine 312 may manage the multimedia content of the display device 120. In one implementation, content management engine 312 may enable the user to select which multimedia content to display on the display device 120 from the downloaded multimedia content. In one implementation, content management engine 122 may download or stream multimedia content.

In an implementation, content management engine 312 may predictively cache (e.g., download) multimedia content before the user has indicated an intent to download such content. For example, if the user is viewing multimedia content on a remote control device (described below) or on another device that may be used to cause content to be downloaded to display device 120, content management engine 312 may begin to cause the content to be cached to the display device before the user indicates to do so. Thus, if the user decides to download the multimedia content it will already be at least partially downloaded. If not, the content management engine 312 may remove the content from the cache.

Synchronizing with another Device

In an implementation, multiscreen synchronizer 314 may synchronize content displayed by other devices. Multiscreen synchronizer 314 may therefore provide functionality that is similar to the mirroring functionality described above, but does not require use of computer system 110. Instead, multiscreen synchronizer 314 may obtain content, timing, and/or other information from another device via a direct connection (e.g., BLUETOOTH), an internal network connection (e.g., via the Intranet), and/or other connection. In a particular implementation, content may be synchronized across multiple nearby display devices 120 in a daisy-chain fashion, in which one display device 120 is synchronized to the next, and so on.

### Detecting Nearby Users and Providing Content Based on the Detected Users

In an implementation, proximity-based content engine 316 may detect a proximity of a particular end user and provide content based on the identity of the end user. For instance, a user may carry or otherwise be associated with a client device 130 that communicates with display device 120. Client device 130 (which may be programmed with remote management application, described below) may provide identification information to display device 120 via a short-range protocol such as BLUETOOTH. Proximity-based content engine 316 may obtain a user profile based on the identification information (e.g., via a request to computer system 110 or based on internally stored information). Using the user profile, proximity-based content engine 316 may select content preferred by the nearby end user or content that proximity-based content engine 316 predicts will be preferred by the nearby end user. In the event that multiple end users are detected, the first end user detected may be used to provide preferred content. Alternatively, preferred content of all detected end users may be cycled.

### Display Controller

In an implementation, display controller 318 may display the multimedia content on the display panel of the digital picture frame. For example, display controller 318 may display the digital images and/or videos selected by the user on the display panel of the digital picture frame. In another implementation, display controller 318 may manage how the multimedia content is displayed. In one use case, display controller 318 may set the sequence or order and the time the multimedia content is displayed. In another implementation, display controller 318 may control the digital picture frame to display any information associated with the multimedia content in the placard panel. In one implementation, display controller 318 may allow the user to manage how the multimedia content is displayed on the digital picture frame. For instance, the user may manage which digital images and/or videos are displayed on the digital picture frame, the order in which they are displayed, and any associated information to be displayed.

In an implementation, display controller 318 may manage one or more display settings of display device 120. The display settings may be controlled locally via input at display device 120 and/or remotely (e.g., from one a client device 130 or from another display device 120). In an implementation, display controller 318 may adjust the display settings based one or more user preferences defined in a user profile. In this implementation, the display preferences may be provided by computer system 110, but may be overridden by manual control/input by the end user at display device 120.

### Modifying Content

In an implementation, content modification engine 320 may alter multimedia content that is displayed. For instance, content modification engine 320 may obtain a datastream (e.g., a weather stream, news ticker, sports scores, etc.) and combine the datastream with the multimedia content that is displayed. Such combination may include an overlay or incorporation of the datastream into the multimedia content. The datastream may include other content as well, such as messages (e.g., social media messages, email messages, etc.), incoming content (e.g., a thumbnail image of content that is being downloaded), calendar reminders, etc. In this manner, content modification engine 320 may augment multimedia content with additional content.

In an implementation, content modification engine 320 may be influenced by ambient information (e.g., information related to an environment or users around display device 120). Content modification engine 320 may obtain sensor information that indicates a lighting condition, a temperature, a humidity, a biometric feature (which may indicate a user's mood), and/or other ambient information. In an implementation, at least some ambient information may refer to inside ambient conditions (e.g., as measured from on-board or accessory sensors) and at least some ambient information may refer to outside ambient conditions (e.g., as measured from external sensors or otherwise received via a network). Content modification engine 320 may modify a color, a brightness, a size, a resolution, and/or other characteristic of multimedia content based on the ambient information.

In an implementation, communication engine 322 may utilize wireless communication to communicate with other digital picture frames and/or user devices. For instance, communication engine 322 may communicate to other digital picture frames and/or user devices via Wireless Local Area Network (WLAN) technology with a WLAN access point or via WiMAX or LTE technology with a WiMAX or LTE base station, Bluetooth technology or perform ad hoc network communication with another WLAN, WiMAX, LTE, and the like.

In an implementation, state indicator 324 may provide an indication to a remote device of the display device's state. For example, state indicator 324 may transmit a remote loading indicator to indicate that the display device is in a loading state (e.g., a state in which content is being downloaded to the display device).

### Display Device Configured as a Digital Picture Frame Device

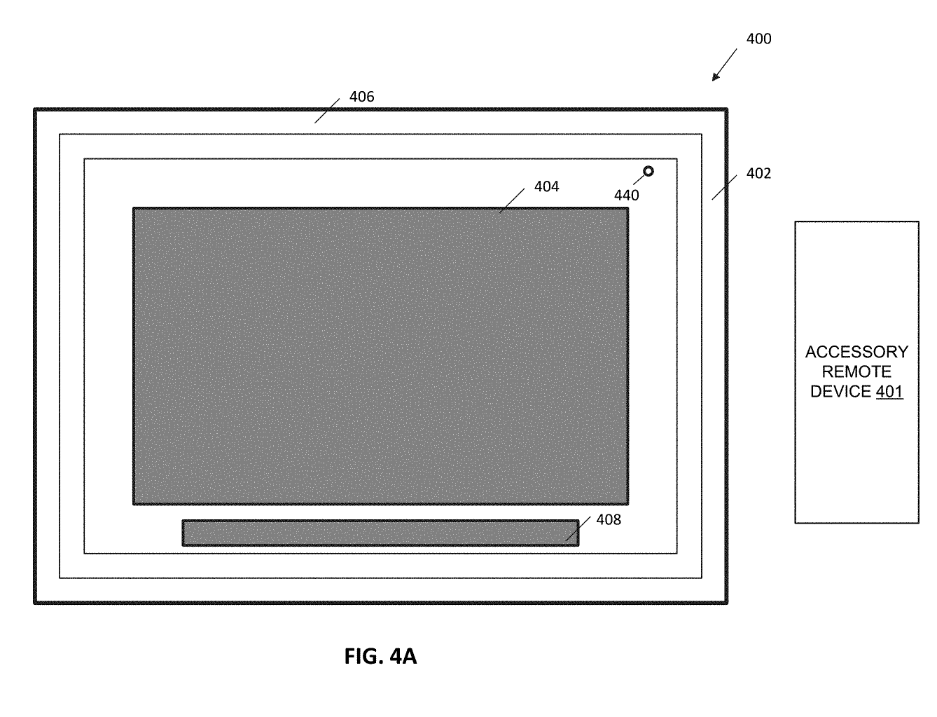

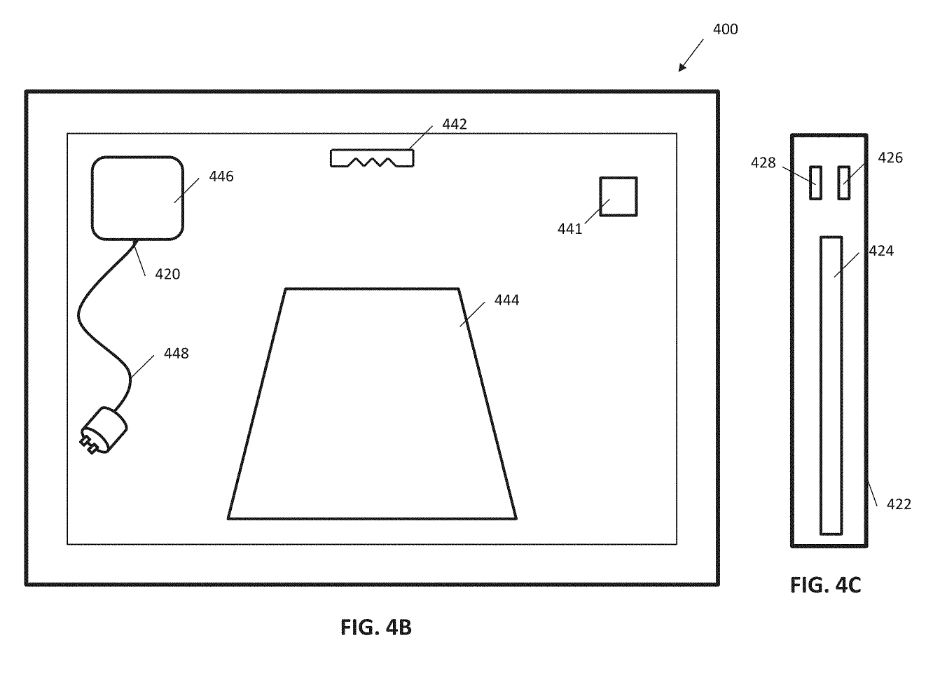

FIG. 4A illustrates a front view of an exemplary digital picture frame device, according to an implementation of the invention. As shown in FIG. 4A, digital picture frame device 400 may include a frame body 402, a display panel 404 (which may have an outer portion 406), a secondary display panel 408, an ambient sensor 440, and/or other components.

Frame body 402 may accommodate a display panel 404 for displaying multimedia content downloaded or streamed to digital picture frame device 400. It should be appreciated that digital picture frame device 400 may have varying display panel sizes, such as, for example, a 23 inch display panel.

Display panel 404 may include a liquid crystal display (LCD) panel, a plasma display panel, an organic light emitting diode (OLED) display panel, electronic ink panel, or other type of display technology.

Frame body 402 may comprise varying sizes and shapes. In one implementation, frame body 402 may include an outer portion, which may be positioned around the exterior of digital picture frame device 400. Outer portion 406 may vary in shape and size and include decorative finishes, styles and colors. In one implementation, outer portion 406 may include a region to support an accessory frame or (not illustrated) such that the user may change the appearance of digital picture frame device 400. For example, an accessory frame may be provided in various decorative finishes, styles and colors which may be selected and snapped-on to the frame body by the user to alter the appearance of digital picture frame device 400.

Secondary display panel 408 may include a liquid crystal display (LCD) panel, a plasma display panel, an organic light emitting diode (OLED) display panel, electronic ink panel, or other type of display technology. Generally, secondary display panel 408 may be smaller than display panel 404, although it may vary in size. In an implementation, secondary display panel 408 may display information associated with the multimedia content displayed on digital picture frame device 400. For example, secondary display panel 408 may display the title, artist, credit information, date of creation, and/or other information associated with multimedia content displayed by display panel 404. Although illustrated as being integrated with frame body 402, secondary display panel 408 may be configured as a separate display panel that may be communicably coupled to digital picture frame device 400. Furthermore, multiple secondary display panels 408 may be coupled to digital picture frame device 400. In these instances, each secondary display panel 408 may display unique information (such as weather or other data streams, messages, and so forth).

In one implementation, ambient sensor 440 may include a light sensor configured to sense ambient light. Such sensed ambient light may be used to set an appropriate brightness range for display panel 406 and/or secondary display panel 408 based on the ambient light present. In one implementation, ambient sensor 440 may be positioned adjacent to display panel 408 to provide the most accurate readings. In another implementation, ambient sensor 440 may be positioned within frame body 402. Other placements may be used as well. Other types of sensors may be used as well.

In an implementation, accessory remote device 401 may be provided that wirelessly or through a wired connection controls digital picture frame device 400. Such remote control may include changing content that is displayed, controlling a game played on the digital picture frame device 400, changing display settings, and/or other controls. Accessory remote device 401 may include various input/output components (not illustrated) such as, for example, a display, speakers, microphone, motion sensor, camera, etc.

In an implementation, accessory remote device 401 may be programmed to provide access to multimedia content available for download to digital picture frame device 400. In some instances, for example, accessory remote device 401 may access computer system 110, access removable memory, access a network such as the Internet, and/or otherwise have access to content to be perused prior to download. For instance, an end user may peruse multimedia content on a display of accessory remote device 401 and select content for download, which may cause the content to be downloaded to digital picture frame device 400.

FIG. 4B illustrates a rear view of an exemplary digital picture frame device, according to an implementation of the invention. As shown in FIG. 4B, in one implementation, digital picture frame device 400 may be wall-mountable via hanging element 442. Hanging element 442 may include hooks, clips, anchors, or equivalents for attaching digital picture frame 442 to a wall. In another implementation, digital picture frame device 400 may be mounted to a wall via a wall mounting system. For example, the wall mounting system may enable the user to adjustably support or position of digital picture frame device 400 on a wall. In some implementations, digital picture frame device 400 may include an accelerometer 441 and/or other orientation sensors. Accelerometer 441 may be configured to generate output signals conveying information related to an orientation of digital picture frame device 400. Display controller 318 may be configured to orientate the display in a portrait orientation and/or in a landscape orientation based on the output signals from accelerometer 441. In one implementation, accelerometer 441 may be coupled with frame body 402. Other placements may be used as well. The wall mounting system may also enable the viewing angle relative to the wall to be adjusted to enhance the viewing experience by the user.

In another implementation, frame body 402 of digital picture frame device 400 may be supported via an accessory stand 444 such that the user may position digital picture frame device 400 on a flat surface. Accessory stand 444 may be connected to digital picture frame device 400 via a hinge or the like such that accessory stand 444 may be retractable to provide a low profile in a closed position if a wall mounted attachment is preferred.

In another implementation, digital picture frame device 400 may include a power supply unit 446 for supplying power to digital picture frame device 400. In one implementation, power supply unit 446 includes a power cord 448 for accessing AC power. In one implementation, power cord 448 is a detachable cord with coupling members 420 such that the cord may be changed. For example, power cord 448 may be provided in various decorative finishes, styles and colors which may be selected by the user and attached to power supply unit 444 to change the appearance of digital picture frame device 400.

FIG. 4C illustrates a side view of an exemplary digital picture frame device, according to an implementation of the invention. With reference to FIG. 4C, digital picture frame device 400 may include a data input unit 422 by which the user inputs multimedia content retrieved from one or more storage devices. Data input unit 422 may connect to one of a memory disc 424, such as CD or DVD; a memory card 426, such as a CompactFlash (CF), MultiMedia Card (MMC), Memory Stick (MS), Secured Digital (SD), and xD-Picture Card (xD); or a USB mass storage device 428. For example, data input unit 422 may be utilized to upload digital images and/or videos from a storage device to be displayed on digital picture frame device 400.

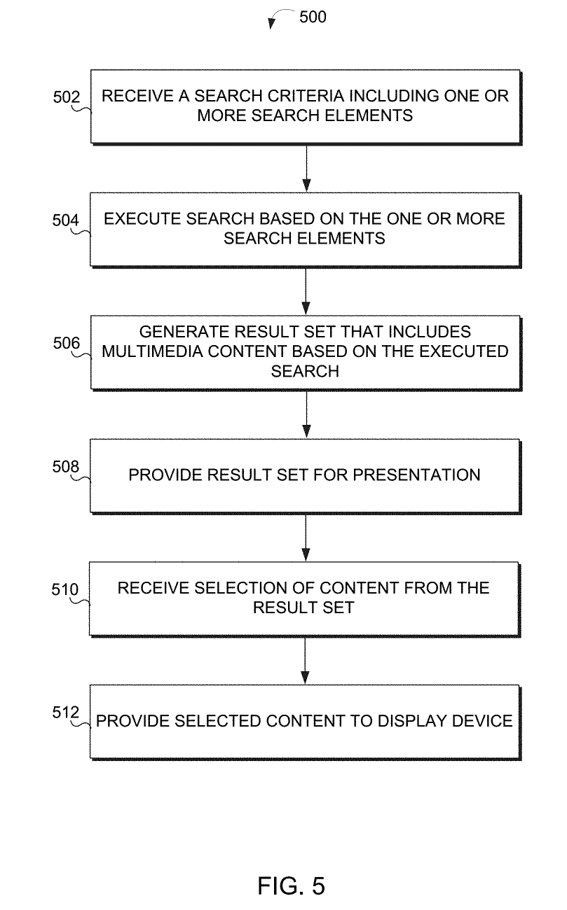

FIG. 5 depicts a process flow diagram for providing multimedia content to a display device, according to an implementation of the invention. The various processing operations and/or data flows depicted in FIG. 5 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 502, a search criteria including one or more search elements corresponding to digital content stored in a database is received from a user. For example, the search parameter may include one or more search terms (e.g., keywords, phrases, etc.), categories of digital content, artist, titles, and/or other parameters associated with the digital content used to search for by a user.

In an operation 504, a search of the database with the one or more search elements is executed. For example, process 500 may execute a search that returns information related to the search parameter, execute a command that produces output related to the search parameter, or otherwise obtain results related to the search parameter.

In an operation 506, a result set of digital content that match the search criteria is generated. For example, the user may select one or more pieces of digital content to be downloaded and/or streamed to the user's registered display device 120. As another example, in response to a user search, one or more digital images and/or videos associated with the user search may be provided. The user may select one or more of the provided digital images and/or videos associated with the user search to be downloaded and/or streamed to the user's display device 120. In one implementation, one or more limited edition digital images and/or videos may include limited availability or restricted access may be provided. In another implementation, one or more subscription-based digital content channels based on a selected category and predetermined schedule may be provided.

In an operation 508, the result set for presentation is provided to the user.

In an operation 510, a selection of digital content to be downloaded to the display device 120 is received from the user.

In an operation 512, the selected digital content is provided to the display device 120. For example, the selected digital content may be uploaded to the user's registered display device 120.

Although illustrated in FIGS. 2 and 3 as a single component, computer system 110 and display device 120 may each include a plurality of individual components (e.g., computer devices) each programmed with at least some of the functions described herein. In this manner, some components of computer system 110 and display device 120 may each perform some functions while other components may perform other functions, as would be appreciated. The one or more processors 202, 302 may each include one or more physical processors that are programmed by computer program instructions. The various instructions described herein are exemplary only. Other configurations and numbers of instructions may be used, so long as the processors 202, 302 are programmed to perform the functions described herein.

Furthermore, it should be appreciated that although the various instructions are illustrated in FIGS. 2 and 3 as being co-located within a single processing unit, in implementations in which processors 202, 302 includes multiple processing units, one or more instructions may be executed remotely from the other instructions. Still further, at least some functions of content management application 210 may be performed by device management application 310 and vice versa.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processors 202, 302 may be programmed by one or more additional instructions that may perform some or all of the functionality attributed herein to one of the instructions.

The various instructions described herein may be stored in storage devices 214, 314, which may comprise random access memory (RAM), read only memory (ROM), and/or other memory. The storage devices 214, 314 may store the computer program instructions (e.g., the aforementioned instructions) to be executed by processors 202, 302 as well as data that may be manipulated by processors 202, 302. The storage device may comprise floppy disks, hard disks, optical disks, tapes, or other storage media for storing computer-executable instructions and/or data.

Network 102 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

The various databases 160 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for managing content of a digital picture frame associated with a user, the method being implemented on a computer system having one or more physical processors programmed with computer program instructions which, when executed, perform the method, the method comprising:
receiving, at the computer system, a search criteria including one or more search elements corresponding to multimedia content stored in a database from the user;
executing, by the computer system, a search of the database with the one or more search elements;
generating, by the computer system, a result set of multimedia content that match the search criteria;
providing, by the computer system, the result set for presentation to the user;
receiving, by the computer system, a selection of multimedia content to be downloaded to the digital picture frame from the user; and
providing, by the computer system, the selected multimedia content to the digital picture frame.

2. The method of claim 1, wherein the multimedia content includes at least digital images and digital videos.

3. The method of claim 1, wherein availability of multimedia content is limited to a predetermined amount of downloads or for a predetermined amount of time.

4. The method of claim 1, wherein the multimedia content includes subscription-based multimedia content channels, the subscription-based multimedia content channels providing multimedia content based on a selected category and predetermined schedule

5. The method of claim 4, wherein availability of subscription-based multimedia content channels is limited to a predetermined amount of downloads or for a predetermined amount of time.

6. The method of claim 1, wherein the multimedia content includes a live performance provided in real-time, and wherein availability of live performance is limited to a predetermined amount of downloads.

7. The method of claim 1, wherein the selection of the multimedia content include selecting a set of digital images; and the method further comprises:
animating the set of digital images at a set framerate.

8. The method of claim 1, wherein the computer system is located remotely from the digital picture frame.

9. The method of claim 8, further comprising:
controlling, by the computer system, the operation and setting of the digital picture frame.

10. The method of claim 1, further comprising:
mirroring, by the computer system, a display of another device to the digital picture frame.

11. A system for managing content of a digital picture frame associated with a user, the system comprising:
a computer system having one or more physical processors programmed with computer program instructions to:
receive a search criteria including one or more search elements corresponding to multimedia content stored in a database from the user;
execute a search of the database with the one or more search elements;
generate a result set of multimedia content that match the search criteria;
provide the result set for presentation to the user;
receive a selection of multimedia content to be downloaded to the digital picture frame from the user; and
provide the selected multimedia content to the digital picture frame.

12. The system of claim 11, wherein the multimedia content includes at least digital images and digital videos.

13. The system of claim 11, wherein availability of multimedia content is limited to a predetermined amount of downloads or for a predetermined amount of time.

14. The system of claim 11, wherein the multimedia content includes subscription-based multimedia content channels, the subscription-based multimedia content channels providing multimedia content based on a selected category and predetermined schedule

15. The system of claim 14, wherein availability of subscription-based multimedia content channels is limited to a predetermined amount of downloads or for a predetermined amount of time.

16. The system of claim 11, wherein the multimedia content includes a live performance provided in real-time, and wherein availability of live performance is limited to a predetermined amount of downloads.

17. The system of claim 11, wherein the computer system is located remotely from the digital picture frame.

18. The system of claim 17, wherein the one or more processors are further programmed to:
control the operation and setting of the digital picture frame.

19. The system of claim 11, wherein the one or more processors are further programmed to:
mirror a display of another device to the digital picture frame.
